(19) United States
(12) Patent Application Publication
(10) Pub. No.: US 2018/0112651 A1
(43) Pub. Date: Apr. 26, 2018

(54) ELECTRICITY GENERATION FROM A TEMPERATURE CONTROL SYSTEM

(71) Applicant: Mark Crabtree, Lancashire (GB)

(72) Inventor: Mark Crabtree, Lancashire (GB)

(21) Appl. No.: 15/650,570

(22) Filed: Jul. 14, 2017

(30) Foreign Application Priority Data
Oct. 21, 2016 (GB) 1617852.7

(51) Int. Cl. F03G 6/06; F01K 25/14; F03G 7/04; F01K 17/00

(52) U.S. Cl. CPC F03G 6/064; F01K 25/14; F03G 2007/007; F01K 17/005; F03G 6/065; F03G 7/04

(57) ABSTRACT

A temperature control system includes: a compressor, a condenser, an expansion valve, and an evaporator all connected in series to form a refrigerant circuit. The system includes an electricity generating arrangement fluidly connected to the refrigerant circuit between the compressor and one of the condenser and the evaporator, the electricity generating arrangement comprising a solar thermal collector adapted to heat refrigerant leaving the compressor, and a fluid driven electricity generator adapted to receive refrigerant heated by the solar thermal collector.

### CROSS-REFERENCE TO RELATED APPLICATIONS

This application claims the benefit under 35 U.S.C. § 119 of Great Britain Patent Application No. 1617852.7, filed Oct. 21, 2016, the entire content of which is incorporated herein by reference.

### TECHNICAL FIELD OF THE INVENTION

The present invention relates to cooling and heating systems such as air-conditioning units and refrigerators, and in particular, to generating electricity from cooling and heating systems which operate using a compression cycle.

### BACKGROUND TO THE INVENTION

Temperature control systems, such as air-conditioning, cooling and refrigeration systems commonly use a compression cycle to either heat or cool their surroundings through respective cooling or heating of a fluid refrigerant. Generally, in a cooling cycle the refrigerant fluid is initially a gas which is compressed by a compressor, subsequently liquefied in a condenser and then injected through an expansion valve. The injection of the highly pressurized, liquid refrigerant through the expansion valve allows the refrigerant to expand rapidly. The refrigerant is then passed through an evaporator in which the refrigerant absorbs heat energy from surrounding air or other fluids which are passed about the evaporator thereby cooling them. This process may run in reverse in order to heat surroundings, whereby hot pressurized refrigerant is passed through the evaporator and the surrounding air or fluids passing over the evaporator absorb this heat.

Temperature control systems of this type generally require a vast amount of energy to operate and it is therefore desirable to improve their overall efficiency. It is known to incorporate into such systems a solar collector in order to use solar energy to heat the refrigerant leaving the compressor. In a cooling cycle, the solar collector is used to increase the pressure and the mass flow rate of refrigerant into the evaporator, increasing the cooling capacity of the evaporator. As a consequence, the system can be operated to produce a desired cooling effect with less power being drawn by the compressor than in a conventional system. Similar arrangements are known to be adopted in a temperature control system configured as a heat pump.

Whilst the known systems are effective, alternative arrangements for increasing the overall efficiency of such temperature control systems are desirable.

It is an aim of aspects of the invention to overcome, or at least partially mitigate, the drawbacks of the known temperature control systems and methods.

It is a further aim of aspects of the invention to provide alternative temperature control systems and methods which are more versatile that the known systems and methods.

### SUMMARY OF THE INVENTION

According to a first aspect of the present invention, a temperature control system includes: a compressor, a condenser, an expansion valve, and an evaporator all connected in series to form a refrigerant circuit. The system includes an electricity generating arrangement fluidly connected to the refrigerant circuit between the compressor and one of the condenser and the evaporator, the electricity generating arrangement comprising a solar thermal collector adapted to heat refrigerant leaving the compressor, and a fluid driven electricity generator adapted to receive refrigerant heated by the solar thermal collector.

Using a solar collector in whatever design to transfer heat energy to the refrigerant after leaving the compressor acts to increase the velocity of the refrigerant which increased velocity flow can be used to drive a fluid powered electric generator in order to produce electricity. The generated electricity can be used to reducing the utility grid, or on site electricity requirement, for a building in which the system is integrated or the energy consumption of the cooling or heating system itself, if returned directly back to the systems consumption. The electrical energy generated may be used as it is produced and/or stored, in a battery or the like, for later use. Thus, electrical energy can be generated during the daytime when sunlight is abundant and stored for subsequent use, say at night, when demands for electrical energy may be greater.

The solar collector may comprise a series of pipes containing a heated fluid (which may be a liquid or gas, and “fluid” hereinafter comprises either or both of a liquid or gas) over which the refrigerant is passed, in use. In this way, as the refrigerant passes over or through the pipes, heat energy is transferred from the fluid within the pipes of the solar collector to the refrigerant causing the refrigerant to heat up. The increase in temperature of the refrigerant causes the pressure to rise or the numbers of molecules to decrease (hence effecting an increase in mass flow means).

Alternatively, the solar collector may comprise a tank containing a heated substance, which may be a fluid or a solid or particulate. In such embodiments, the refrigerant pipes of the system may be configured such that at least a portion of the pipes at the solar collector system are submerged within that tank. Such embodiments work in a similar manner to that described above, wherein energy from the heated substance within the tank is transferred to the refrigerant flowing through the pipes which are submerged within the tank.

In some embodiments there is provided at least two electrical generating arrangements, each comprising a solar collector and a fluid powered electrical generator, in parallel and at least one further electrical generating arrangement comprising a solar collector and a fluid powered electrical generator located in series with at least one of the parallel connected electrical generating arrangements. In this way, by controlling the operation of each of the electrical generating arrangements independently, the rate at which the refrigerant is pressurized in use may be varied.

The solar collector may also contain a hot water storage tank in which water heated by solar energy when sunlight is available can be stored in order that the refrigerant can be heated by the water during periods where there is insufficient sunlight.

In some embodiments the compressor may comprise a first compressor and the system may additionally comprise one or more further compressors. Any further compressor may be located in series with the first compressor. Alternatively, each further compressor may be located in parallel with the first compressor. In some embodiments there is provided at least one further compressor in parallel with the first compressor and at least one further compressor located in series with the first compressor such that there is provided an array of compressors. In this way, by controlling the operation of the first compressor and the one or more further compressors, the rate at which the refrigerant is compressed in use may be varied.

In other embodiments, the rate at which the first compressor runs may be variable, removing the requirement to have one or more further compressors to vary the rate of compression of the refrigerant in use. However, in some embodiments it may still be desirable to have one or more further compressors in addition to the variable rate first compressor.

In some embodiments the system may comprise a plurality of evaporators. In use, the evaporators may be physically spaced apart so as to act to either cool or heat various different areas within an environment to be cooled/heated. In such embodiments, the system may additionally comprise a distributor operable to separate the refrigerant flow into a plurality of separate flows, at least one to each of the plurality of evaporators. The distributor may be placed directly after the condenser. In such embodiments, there may be provided an expansion valve for each of the evaporators.

The system may additionally comprise a collector, operable in use to combine the plurality of separate flows from each of the evaporators back into a single main refrigerant flow.

In some embodiments the system may comprise a number of refrigerant pipes through which the refrigerant may flow, in use. At least two of the plurality of refrigerant pipes may be placed in parallel with each other in the system. In this way, the overall resistance within the system, or the resistance to the flow of the refrigerant around the system, or at least through the portion of the system comprising the parallel refrigerant pipes, is reduced as the effective heat transfer surface of the system is increased.

In some embodiments the system may comprise one or more valves. The one or more valves may be operable to control the flow of the refrigerant through the system, in use. In some embodiments at least one of the one or more valves may comprise a one-way valve. The/each one way valve may be operable in use to prevent refrigerant from flowing in an undesired direction.

In some embodiments at least one of the one or more valves may comprise a stop valve. The/each stop valve may be operable in use to control the flow of refrigerant through the system in the desired direction. Such control may comprise controlling which components the refrigerant flows through and the flow rate at any given time. This may be desirable in embodiments wherein there is provided an array of compressors and it is required to control the compression rate of the refrigerant. Similarly, this may be desirable to control which electrical generating arrangement the refrigerant is passed through to control the extent of the velocity of the compressed refrigerant.

In some embodiments at least one of the one or more valves comprises a security valve. The/each security valve may be operable in use to direct refrigerant within a given refrigerant pipe away from said pipe. In use, this may be desirable to ensure that there are no unwanted build-ups of pressure within a refrigerant pipe which may lead to the pipes becoming damaged or, in the worst case, rupturing. The/each security valve may be located after the compressor/s array to prevent over pressurized refrigerant from the solar collector passing back through the compressor and potentially causing damage thereto.

In some embodiments the temperature control system is operable in use to act as a cooling system, cooling the environment in which it is positioned. For example, the temperature control system may form part of a refrigerator or air-conditioning unit. Alternatively, the temperature control system is operable in use to act as a heating system, heating the environment in which it is positioned. For example, the temperature control system may form part of a heater, such as a convection heater.

In some embodiments the temperature control system may act as both a cooling system and a heating system at different times. For example, the temperature control system may form part of an air-conditioning unit or climate control unit which is operable in use to either heat or cool the environment in which it is placed to a predetermined level. To allow for this, the system may comprise a four-way-valve operable in use to direct the flow of the refrigerant around the system in either of a first direction or a second direction. The first direction may comprise a cooling direction in which the refrigerant flows sequentially from the compressor to the electricity generating arrangement, to the condenser, through the expansion valve, on to the evaporator and back to the compressor. The second direction may comprise a heating direction in which the refrigerant flows sequentially from the compressor, to the electricity generating arrangement, to the evaporator, then through the expansion valve, on to the condenser and finally back to the compressor.

The system may additionally comprise a control unit. The control unit may be operable in use to control the operation of one or more of the components of the system, including the compressor, the/each electricity generating system, the condenser, the expansion valve and/or the evaporator. In relevant embodiments, the control unit may additionally or alternatively be operable to control the operation of the one or more further compressors, any of the plurality of evaporators and/or the operation of any of the one or more valves. For example, the control unit may control the rate at which the compressor acts to compress the refrigerant, and/or may control the flow of the refrigerant through the valves to each component. The control unit may be an electronic control unit. Such an electronic control system may have an ICU which may be configured to regulate the system in accordance with predefined protocols and in dependence on various inputs.

In some embodiments, the system additionally comprises one or more sensors located within the refrigerant flow. The one or more sensors may be operable in use to monitor one or more parameters of the refrigerant, such as its temperature and/or pressure, at a certain point within the system. In some embodiments the sensors may be connected to the control unit.

In such embodiments, the control unit may be operable to control the operation of one or more of the components of the system in response to the values of the parameters measured by the one or more sensors. In some embodiments the system may be configured to prevent desegregation of dispensed oil at unfavourable locations, and which may therefore cause a lack of oil supply to the compressor.

According to a second aspect of the present invention, a method is provided of operating a temperature control system including: a compressor, a condenser, an expansion valve, and an evaporator all connected in series to form a refrigerant circuit; and an electricity generating arrangement fluidly connected in the circuit between the compressor and one of the condenser and the evaporator, the electricity generating arrangement comprising a solar thermal collector adapted to heat refrigerant from the compressor, and a fluid driven electricity generator adapted to receive refrigerant heated by the solar thermal collector. The method includes: using the solar collector to increase the velocity of the refrigerant leaving the compressor; and using the increased velocity refrigerant to drive the fluid driven electricity generator in order to generate electricity.

According to a third aspect of the present invention there is provided a method of cooling an environment using a system in accordance with the first aspect of the present invention comprising the steps of:
(a) using the compressor to compress and/or heat a refrigerant;
(b) increasing the velocity of the compressed refrigerant by passing the refrigerant through the solar collector to transfer energy to the refrigerant, increasing velocity of the refrigerant;
(c) generating electricity as the refrigerant passes through the fluid powered electricity generator;
(d) condensing the heated refrigerant by passing the refrigerant through a condenser; and
(e) evaporating the condensed refrigerant by passing the refrigerant through an evaporator.

According to a fourth aspect of the present invention there is provided a method of heating an environment using a system in accordance with the first aspect of the present invention comprising the steps of:
(a) using the compressor to compress or heat a refrigerant;
(b) increasing the velocity of the compressed refrigerant by passing the refrigerant through the solar collector to transfer energy to the refrigerant, increasing velocity of the refrigerant;
(c) generating electricity as the refrigerant passes through the fluid powered electricity generator;
(f) passing the heated refrigerant through an evaporator; and
wherein passing the heated refrigerant through the evaporator further comprises passing air or another fluid from the environment over the evaporator to transfer heat energy within the refrigerant to the fluid refrigerant thereby increasing the temperature of the fluid passed over the evaporator which is subsequently supplied back to the environment to be heated.

The method of the third or fourth aspects of the present invention may comprise passing the refrigerant through a solar collector which comprise a series of pipes having a heated fluid located therein. Alternatively, either method may comprise passing the refrigerant through a solar collector which comprise a tank containing a heated fluid. In either case, energy from the heated fluid is transferred to the refrigerant.

Either method may comprise controlling the operation of the/each solar collector independently. In this way, the rate at which the refrigerant is heated by the solar collector may be varied.

A further heat source may be water or other liquids which may be heated by solar thermal collectors in a separate circuit, which is passed through the solar collector to heat up the refrigerant. This circuit may also contain a hot liquid storage tank which would allow the refrigerant to be heated in the absence of direct sunlight.

The method of the third or fourth aspect of the invention may be performed using a system comprising a plurality of compressors, the method comprising independently controlling the operation of each of the compressors. In this way, the rate at which the refrigerant is compressed in use may be varied. In other embodiments, such as those wherein the system comprises only a single compressor, the method may comprise varying the rate at which the single compressor runs.

The method of the third or fourth aspects of the present invention may comprise controlling the temperature at more than one location within an environment. In such embodiments the method may be performed using a system comprising a plurality of evaporators.

The method of the third or fourth aspect of the invention may comprise using one or more valves to control the flow of the refrigerant through the system. In some embodiments at least one of the one or more valves may comprise a one-way valve, or may comprise a stop valve, for example. In such embodiments, the method may comprise controlling which components the refrigerant flows through at any given time. This may be desirable in embodiments herein there is provided an array of compressors and it is required to control the compression rate of the refrigerant. Similarly, this may be desirable to control which of one or more solar collectors the refrigerant is passed through to control the extent to which the compressed refrigerant is energized.

In some embodiments of the third or fourth aspects of the invention, the method comprises using a security valve to direct refrigerant within a given refrigerant pipe away from said pipe. This may be desirable to ensure that there are no unwanted buildups of pressure within a refrigerant pipe which may lead to the pipes becoming damaged or, in the worst case, rupturing. In some embodiments, the method may comprise using a security valve to prevent over pressurized refrigerant from the solar collector passing through to the condenser and/or evaporator/s and potentially causing damage.

The method of either of the third or fourth aspects of the invention may comprise using a control unit to control the operation of one or more of the components of the system, including the compressor, the/each electrical generating arrangement, the condenser, the expansion valve and/or the evaporator. In relevant embodiments, the method may also comprise using a control unit, either additionally or alternatively, to control the operation of the one or more further compressors, any of the plurality of evaporators and/or the operation of any of the one or more valves. For example, the method may comprise using the control unit to control the rate at which the compressor acts to compress the refrigerant, and/or control the flow of the refrigerant through the valves to each component. The control unit may be an electronic control unit. Such an electronic control system may have an ICU which may be configured to regulate the system in accordance with predefined protocols and in dependence on various inputs.

In some embodiments of the third or fourth aspects of the invention the method may comprise monitoring one or more parameters of the refrigerant, such as its temperature and/or pressure. In such embodiments, the method may comprise using one or more sensors located within the refrigerant flow to monitor said parameters. In some embodiments, the operation of one or more of the components of the system in response to the values of the parameters measured by the one or more sensors. The method may comprise using a control system in communication with the sensor/s to monitor and subsequently control the operation of the system.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE INVENTION DRAWINGS

In order for the invention to be more clearly understood, embodiments thereof will now be described, by way of example only, with reference to the accompanying drawings, of which:

FIG. 1 is a schematic drawing illustrating a first embodiment of a temperature control system in accordance with an aspect of the invention, in which the system is configured in a cooling cycle;

FIG. 2 is a schematic drawing illustrating a second embodiment of a temperature control system in accordance with an aspect of the invention, in which the system is configured in a heating cycle;

FIG. 3 is a schematic drawing illustrating a further embodiment of a temperature control system in accordance with an aspect of the invention, in which the system is similar to that of FIG. 1 but incorporates a bypass arrangement to selectively allow refrigerant to be routed directly from the compressor to the condenser, bypassing the electricity generating arrangement; and

FIG. 4 is a schematic drawing illustrating a further embodiment of a temperature control system in accordance with an aspect of the invention which can be operated in either a cooling cycle or a heating cycle and which incorporates a bypass arrangement to selectively allow refrigerant to be routed directly from the compressor to either the condense or the evaporator depending on which cycle is in operation.

### DETAILED DESCRIPTION

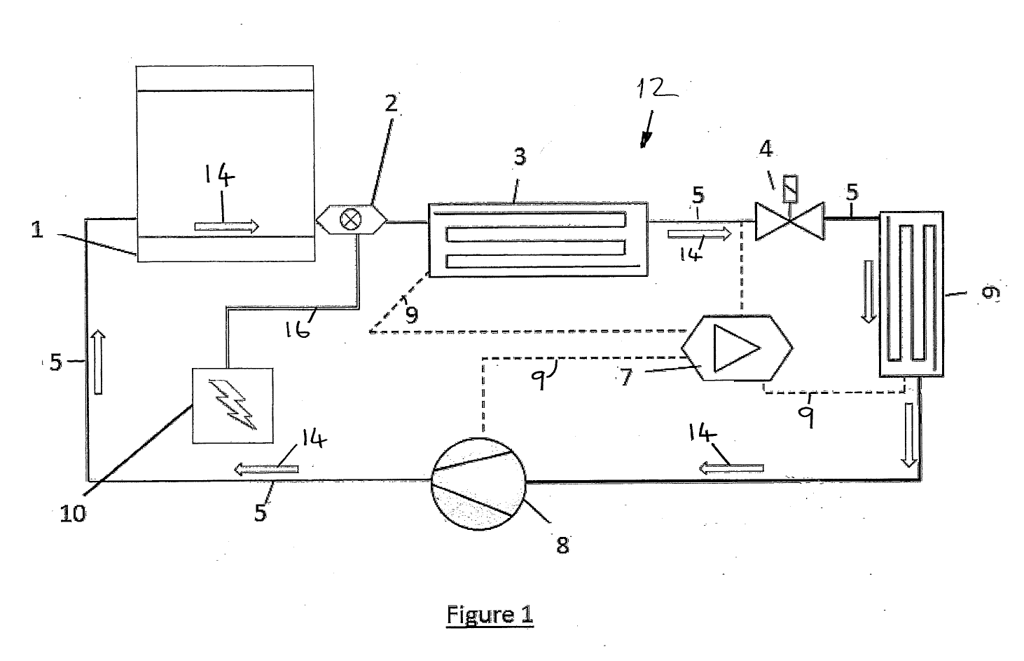

FIG. 1 illustrates schematically a temperature control system 12 incorporating an electricity generating arrangement 1, 2 in accordance with an aspect of the invention, the system being configured in a cooling cycle. The direction of flow of the refrigerant about the circuit being indicated by the arrows 14. The electricity generating arrangement 1, 2 is fluidly connected in the circuit directly after the compressor 8 and before the subsequent condenser 3 and is fluidly connected to the compressor 8 and condenser 3 through suited refrigerant pipes 5. The electricity generating arrangement includes a solar thermal collector 1 designed to heat the refrigerant and a fluid driven electricity generator 2 which is driven by the refrigerant after it has been heated by the solar collector and so is travelling at an increased velocity when compared with the refrigerant flowing from the compressor to the solar thermal collector. The refrigerant leaves the compressor in gaseous state and is then pushed through the solar collector 1, where it is absorbs heat energy thus creating increased velocity. The refrigerant gas then flows through the fluid driven electricity generator 2 under pressure to create electricity 10. The refrigerant then continues on into the condenser 3, to expansion valve 4, and finally to the evaporator 6, before returning to the compressor 8 in the usual way for a cooling cycle. The refrigerant as it is passed through the evaporator absorbs heat energy from surrounding air or other fluids which are passed about the evaporator thereby cooling them. The driven electricity generator 2 is connected to an electrical circuit by means of suitable cables 16. The electricity 10 generated can be used to charge a battery for later use and/or used as it is generated. The electricity could be used in a building in which the system is located or by the temperature control system itself or for any other suitable use.

The temperature control system 12 is has an electronic control system including a central control unit 7 to control the operation of at least some of the components of the temperature control system 12, such as the compressor 8, the electrical generating arrangement 1, 2, the condenser 3, the expansion valve 4, and/or the evaporator 6. The control unit 7 is an electronic control unit having an ICU and is connected to the various components under its control through transmission lines 9. The control unit 7 is configured to regulate the temperature control system 12 in accordance with predefined protocols and in dependence on various inputs which may be from sensors which monitor one or more parameters of the system, such as the temperature and/or pressure of the refrigerant at certain point within the system, and/or user inputs.

The temperature control system 12 in accordance with the invention makes use of available solar energy to increase the energy in the refrigerant and uses this to generate electricity which can be used, directly or indirectly, to off-set the power consumed by the system in operating the compressor and so increases the overall efficiency of the system.

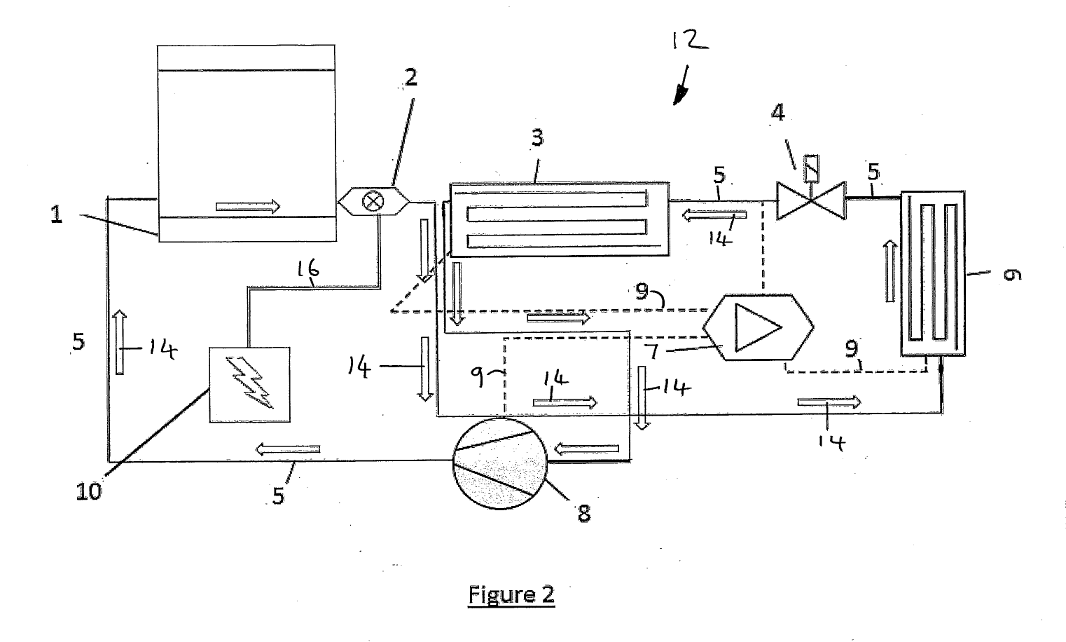

FIG. 2 illustrates schematically a temperature control system incorporating an electricity generating arrangement 1, 2 in accordance with an aspect of the invention configured in a heat pump cycle. This embodiment is similar to the first embodiment except that the refrigerant leaving the fluid powered electricity generator is directed into the evaporator 6, then to expansion valve 4, then the condenser 3, before returning to the compressor 8 in order to operate as a heat pump in a known way. This embodiment can be used to generate electricity 10 in a similar manner to that described above in relation to the first embodiment by heating the refrigerant passing through the solar collector 1 to increase its velocity and using the increased velocity of the refrigerant to drive the electricity generator 2.

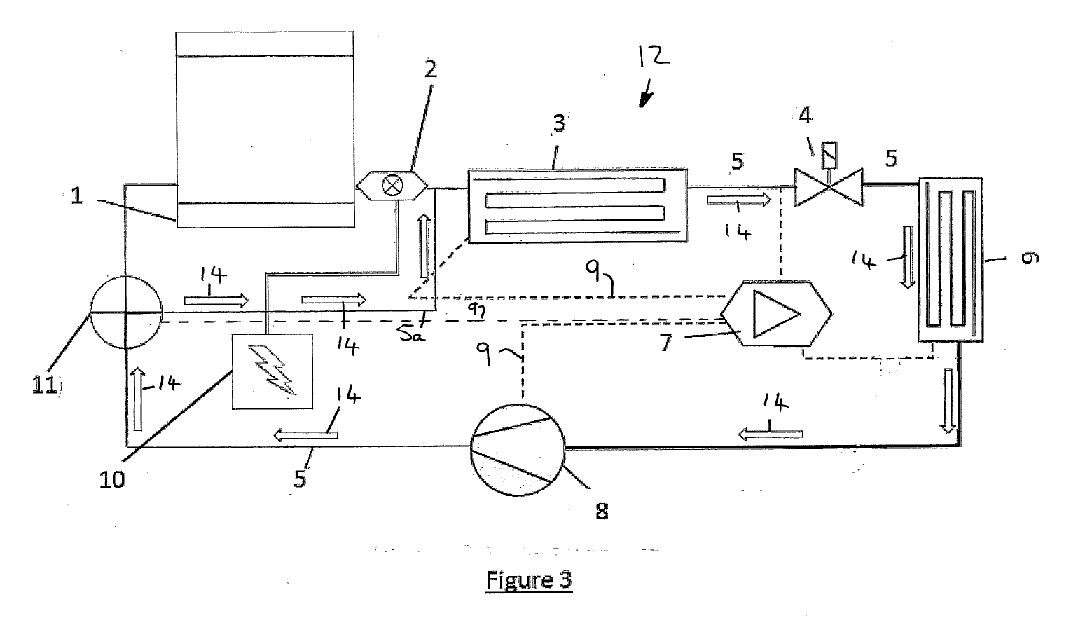

FIG. 3 illustrates a further embodiment of a temperature control system which is similar to that shown in FIG. 1 and as described above, in which the system is configured in a cooling cycle. The embodiment of FIG. 3 differs in that it includes a bypass arrangement with a diverter valve 11 to allow refrigerant to be routed directly from the compressor to the condenser, bypassing the electricity generating arrangement 1, 2. This may be useful, for example, when there is insufficient sunlight available to enable electricity to be generated cost effectively and/or without compromising the effectiveness of the system to cool a designated area. FIG. 3 shows the circuit with the bypass open so that all the refrigerant is routed through additional bypass pipes 5a from the compressor into the main flow path downstream of the generator 2 so as to flow directly to the condenser 3.

The diverter 11 is integrated in the circuit directly after the compressor 8 and before the solar collector 1 and connected to compressor 8, the solar collector 1, and the condenser 3 through suited refrigerant pipes 5, 5a. The bypass system is electronically controlled by electronic control; system 7 which includes sensors for measuring the temperature of the refrigerant leaving the compressor 8 and the temperature inside the solar collector 1. In normal operation wherein electricity 10 is being generated by the generator 2, the diverter 11 is switched to direct refrigerant from the compressor 8 through the solar collector 1 and the electricity generator 2 as previously described. In circumstances where If the solar collector 1 is not able to increase the velocity of the refrigerant by an amount sufficient to make generation of electricity viable, the diverter 11 can be switched as shown to allow the refrigerant to bypass the solar collector 1 and turbine 2 and to flow directly to the from the compressor 8 to condenser 3. The refrigerant then flows around the remaining circuit in the usually way, through the expansion valve 4 and to the evaporator 6, before returning to the compressor 8 as indicated by the arrows 14. The diverter 11 could also be operated to allow some of the refrigerant to bypass the electricity generating arrangement 1, 2 in circumstances where the temperature of the refrigerant may be raised so much when passing through the solar collector that it could give rise to a dangerous increase in pressure in the system. Thus the diverter 11, or a similar control arrangement, can be used to regulate and vary the flow of refrigerant through the solar collector 1. Typically, the diverter will be connected with the central control unit 7 by suitable transmission lines for automated control.

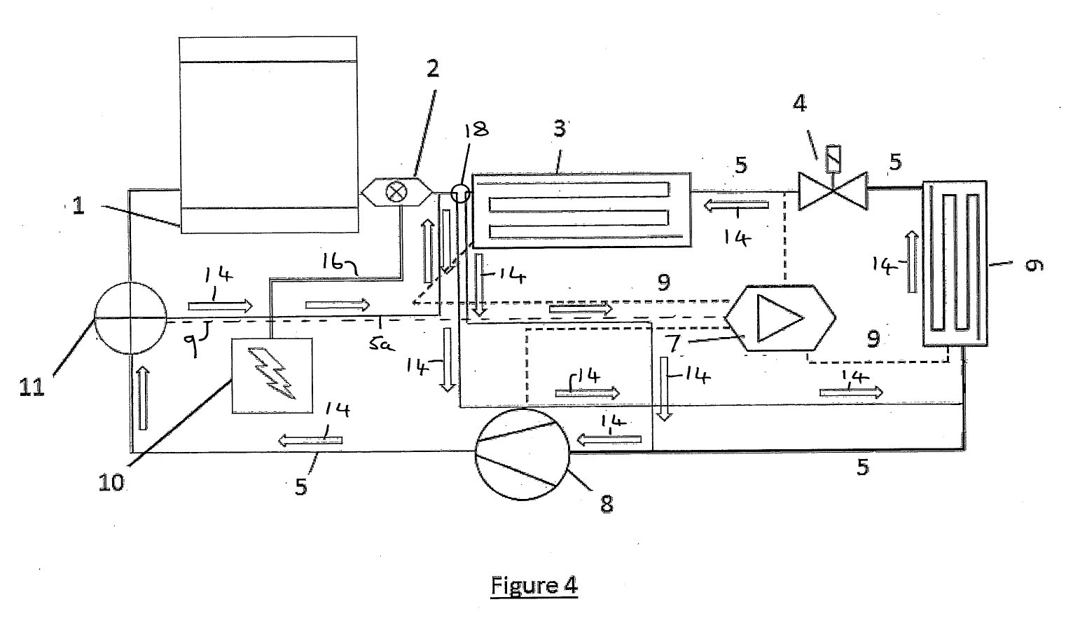

FIG. 4 illustrates a further embodiment of a temperature control system 12 in accordance with an aspect of the invention and which can be operated in either a cooling cycle or a heating cycle. The circuit includes a four-way valve (illustrated schematically at 18) in the circuit downstream of the electricity generator 2. The valve 18 is fluidly connected to the various components so that in one position of the valve the refrigerant is directed to flow in a first direction sequentially through the condenser 3, expansion valve 4, evaporator 6, and back to the compressor 8 in a cooling cycle and in a second position of the valve the refrigerant is directed to flow in the reverse direction sequentially through the evaporator 6, expansion valve 4, condenser and back to the compressor 8 in a heating cycle. FIG. 4 illustrates the valve 18 in the second position so that the circuit is configured to operate in a heating cycle.

The temperature control system 12 as shown in FIG. 4 also includes a bypass arrangement similar that shown in FIG. 3 and described above. The bypass pipes 5a from the diverter 11 are connected to the main fluid path downstream of the electricity generator 2 but upstream of the four way valve 18 so that the circuit can be configured in a cooling or heating cycle whether the bypass is operative or not. It will be appreciated that in alternative embodiments, the temperature control system as shown in FIG. 4 could omit the bypass arrangement and that a bypass arrangement could be included in a temperature control system 12 that is permanently configured to operate in a heat cycle, such as that shown in FIG. 2. The four-way valve is typically an electronic valve controlled by the electronic control 7.

In alternative embodiments of the temperature control system 12 incorporating a bypass arrangement, the diverter 11 could be located between the solar collector 1 and the electricity generator 2 so that only the electricity generator 2 is bypassed.

The solar collector 1 can be any suitable type of solar thermal collector for transferring solar energy obtained from the sun to the refrigerant. The solar collector 1 could include one or more solar panels through which the refrigerant is passed to absorb heat energy from the sun as it falls on the panel, for example. However, the solar collector 1 could comprise a fluid or other substance which is heated by solar energy from the sun and a heat exchanger arrangement for transferring heat energy from the fluid or substance into the refrigerant. In this type of arrangement, the solar collector could be used to heat a fluid, such as water, or other substance which is stored in a tank and the refrigerant passed through coils in the tank so as to be heated by the water or substance. This would enable electricity to be generated using energy from a previously heated and stored fluid to heat the refrigerant during periods where there may be insufficient sunlight to heat the refrigerant directly by a sufficient amount.

The solar collector 1 could include more than one solar collector unit arranged in an array. In this case, the solar collector units could be connected in parallel and/or in series and control means used to regulate the flow through the various solar collector units so as to regulate the amount of energy transferred into the refrigerant. For example, during periods of intense sunlight, only one or some of the available solar collector units may be used to prevent overheating of the refrigerant. Various flow control valves, which may be electronically controlled, can be used to regulate the flow of refrigerant through the various solar collector units.

The fluid powered electricity generator 2 can be of any suitable type and may be a fluid powered turbine.

The fluid powered electricity generator 2 may include more than one fluid powered electricity generator unit 2 arranged in array. In this case, the electricity generator units can be connected in parallel and/or in series.

The person skilled in the art will appreciate that there are numerous ways in which a number of solar collector units 1 and/or electricity generating units 2 can be incorporated into a temperature control system in accordance with an aspect of the invention. For example, two or more solar collector units 1 could be connected in series to have a cumulative effect on the refrigerant passing through them and these can be connected in series to one or more electricity generating units 2. Where there is more than one electricity generating unit, these may themselves be in parallel or series with one another. Alternatively, two or more solar collector units 1 could be connected to the compressor in parallel with one another, with each unit being connected in series with a respective electricity generator unit 2. Various combinations of parallel and series connected solar collector units 1 and electricity generator units could be adopted.

The above embodiments are described by way of example only. Many variations are possible without departing from the scope of the invention as defined in the appended claims. For example, whilst the embodiments as illustrated in the accompanying drawings are relatively simple, including only a single compressor 8 and evaporator 6 in the circuit, it will be appreciated that the concept of generating electricity by transferring energy captured from the sun, or indeed some other external source, into the refrigerant leaving the compressor in order to increase its pressure and velocity and using then refrigerant to drive a fluid powered electricity generator can be incorporated into a wide range of alternative temperature control systems utilizing a compression cycle. For example, such a temperature control system might include multiple evaporators 6 to enable the temperature in more than one area to be controlled and/or multiple compressors.

1. A temperature control system comprising: a compressor, a condenser, an expansion valve, and an evaporator all connected in series to form a refrigerant circuit; and an electricity generating arrangement fluidly connected to the refrigerant circuit between the compressor and one of the condenser and the evaporator, the electricity generating arrangement comprising a solar thermal collector adapted to heat refrigerant leaving the compressor, and a fluid driven electricity generator adapted to receive refrigerant heated by the solar thermal collector.

2. A temperature control system as claimed in claim 1, the system being configured in a cooling cycle such that, in use, refrigerant is directed in sequence from the fluid driven electricity generator to the condenser and from the condenser through the expansion valve to the evaporator before being returned to the compressor.

3. A temperature control system as claimed in claim 1, the system being configured in a heating cycle such that, in use, refrigerant is directed in sequence from the fluid driven electricity generator to the evaporator and from the evaporator through the expansion valve to the condenser before being returned to the compressor.

4. A temperature control system as claimed in claim 1, the system being selectively configurable in a cooling cycle or a heating cycle, the system having a fluid flow control arrangement operative in use to direct refrigerant from the electricity generator to flow through the remainder of the refrigerant circuit back to the compressor in either a cooling cycle direction or a heating cycle direction.

5. A temperature control system as claimed in claim 1, the system incorporating a bypass arrangement selectively operable in use to direct some or all of the refrigerant from the compressor to said one of the condenser and evaporator bypassing at least the fluid driven electricity generator of the electricity generating arrangement.

6. A temperature control system as claimed in claim 5, wherein the bypass arrangement is operable in use to direct some or all of the refrigerant from the compressor to said one of the condenser and evaporator bypassing both the solar collector and the fluid driven electricity generator.

7. A temperature control system as claimed in claim 1, wherein the solar thermal collector comprises an array of two or more solar thermal collector units.

8. A temperature control system as claimed in claim 1, wherein the fluid driven electricity generator comprises an array of two or more fluid driven electricity generator units.

9. A temperature control system as claimed in claim 1, wherein the electricity generating arrangement comprises at least two solar thermal collector units fluidly connected to the compressor in parallel with one another, each of said at least two solar thermal collector units being connected in series with a respective fluid driven electricity generator unit.

10. A temperature control system as claimed in claim 7, wherein the system comprises a flow control arrangement operable to selectively vary the rate of flow of refrigerant through each solar collector unit in the array.

11. A temperature control system as claimed in claim 8, wherein the system comprises a flow control arrangement operable to selectively vary the rate of flow of refrigerant through each fluid driven electricity generator unit.

12. A temperature control system as claimed in claim 1, wherein each of the fluid driven electricity generator units comprises an electricity generating turbine.

13. A temperature control system as claimed in claim 1, the system comprising an electrical energy storage device adapted to store electrical energy generated by the fluid driven electricity generator.

14. A temperature control system as claimed in claim 13, wherein the electrical energy storage device comprises a battery.

15. A temperature control system as claimed in claim 1 the system comprising a flow control arrangement adapted to vary the rate at which refrigerant is passed to the solar thermal collector.

16. A temperature control system of claim 1, wherein the system is configured such that in use, the solar collector is operable to increase the velocity of refrigerant flowing from the compressor to the fluid driven electricity generator.

17. A temperature control system as claimed in claim 1, wherein the compressor comprises a first compressor and the system comprises at least one second compressor.

18. A temperature control system as claimed in claim 1, the system comprising an electronic control system adapted to regulate the flow of refrigerant about the circuit in use.

19. A temperature control system as claimed in claim 18, the system incorporating a bypass arrangement selectively operable in use to direct some or all of the refrigerant from the compressor to said one of the condenser and evaporator bypassing at least the fluid driven electricity generator of the electricity generating arrangement, the control system comprising a sensor arrangement adapted to determine the temperature of the refrigerant at one or more positions about the circuit and being operative in use to regulate the flow of the refrigerant through the electricity generating arrangement and the bypass arrangement in dependence on the measured temperature.

20. A temperature control system as claimed in claim 19, the control system comprising a sensor arrangement adapted to determine the temperature of the refrigerant leaving the compressor and the temperature inside the solar collector and being operative in use to regulate the flow of the refrigerant through the electricity generating arrangement and the bypass arrangement in dependence on the difference between the temperature of the refrigerant leaving the condenser and the temperature inside the solar collector.

21. (canceled)

22. A method of operating a temperature control system comprising: a compressor, a condenser, an expansion valve, and an evaporator all connected in series to form a refrigerant circuit; and an electricity generating arrangement fluidly connected in the circuit between the compressor and one of the condenser and the evaporator, the electricity generating arrangement comprising a solar thermal collector adapted to heat refrigerant from the compressor, and a fluid driven electricity generator adapted to receive refrigerant heated by the solar thermal collector; the method comprising: using the solar collector to increase the velocity of the refrigerant leaving the compressor; and using the increased velocity refrigerant to drive the fluid driven electricity generator in order to generate electricity.

23. A method as claimed in claim 22, the method comprising storing the electrical energy generated for later use.

24. A method as claimed in claim 22, wherein the method comprises selectively directing at least some of the refrigerant from the compressor to said one of the condenser or evaporator bypassing the electricity generating arrangement when the solar thermal collector is unable to increase the velocity of the refrigerant by a pre-determined amount.

25. (canceled)
